(19) United States
(12) Patent Application Publication
(10) Pub. No.: US 2007/0194486 A1
(43) Pub. Date: Aug. 23, 2007

(54) Ophthalmic lens inspection processing aid

(76) Inventors: Kerry T. Sanders, Jacksonville, FL (US); Michael F. Widman, Jacksonville, FL (US); James D. Ford, Orange Park, FL (US); Frank F. Molock, Orange Park, FL (US)

Correspondence Address: PHILIP S. JOHNSON;JOHNSON & JOHNSON, ONE JOHNSON & JOHNSON PLAZA, NEW BRUNSWICK, NJ, 08933-7003, US

(21) Appl. No.: 11/125,058

(22) Filed: May 9, 2005

(51) Int. Cl. B28B 11/00; B29B 15/00

(52) U.S. Cl. 264/232; 264/233

(57) ABSTRACT

The present invention discloses improved methods and systems for inspecting an ophthalmic lens by exposing the ophthalmic lens to a processing aid solution that includes RCO₂CH₂CH₂0(CH₂CH₂O)ₓCH₂CH₂O₂CR where R comprises (equals) at least one of: CF₃CF₂(CF2)ₓCH₂; CH₃CH₂(CH2)ₓCH₂; and Ry[Si(CH₃)2o]ₓ(CH2)₃, while the lens is contained in a ophthalmic lens receptacle, in order to facilitate the removal of bubbles and center the lens in the ophthalmic lens receptacle with a reduced incidence of ophthalmic lenses being folded over on themselves. The decreased incidence of bubbles and proper positioning of the ophthalmic lens in turn facilitates accurate inspection.

### FIELD OF USE

The present invention generally relates to systems for inspecting ophthalmic lenses, and more particularly, to processing aids suitable to facilitate accurate inspection of ophthalmic lenses on a high speed, automated manufacturing line.

### BACKGROUND

Contact lenses have been used commercially to improve vision for many years. The first contact lenses were made of hard materials. Although these lenses are currently used, they are not suitable for all patients due to their poor initial comfort and their relatively low permeability to oxygen. Later developments in the field gave rise to soft contact lenses, based upon hydrogels, which are extremely popular today. These lenses have higher oxygen permeability and are often more comfortable to wear than contact lenses made of hard materials.

Automated systems have been developed for producing ophthalmic lenses, and in particular, contact lenses; and, for example, one such system is disclosed in U.S. Pat. No. 5,080,839. Such systems have achieved a very high degree of automation; and, for instance, the lenses may be molded, removed from the molds, further processed, and packaged without any direct human involvement.

In automated systems, ophthalmic lenses are typically made with a high degree of precision and accuracy. Nevertheless, on rare occasions, a particular lens may contain some irregularity; and, in addition, it is possible that some processes damage the lens, such as, for example, during separation of lens mold portions. For this reason, ophthalmic lenses are inspected before sale to the consumer and deficient lenses are removed from the automated system to be certain that any lens sold is acceptable for consumer use. Although manual inspections are possible, automated inspection systems have proven very efficient at identifying imperfect lenses.

Automated inspection systems can include, for example a transport subsystem for moving the lenses into an inspection position, and an illumination subsystem to generate a light beam and to direct the light beam through the lenses. An imaging subsystem can generate a set of signals representing selected portions of the light beam transmitted through the lenses, and a processing subsystem to process those signals according to a predetermined program. The illumination subsystem can include a light source to generate a light beam and a diffuser to form that light beam with a generally uniform intensity across the transverse cross section of the light beam. The illumination subsystem can further include a lens assembly to focus a portion of the light beam onto an image plane, and to focus a portion of the light beam onto a focal point in front of the image plane to form a diffuser background pattern on the image plane. Aberrations in the light beam can indicate a sub-optimum lens. (Inspection systems have been disclosed for example in U.S. Pat. No. 5,500,732, which is incorporated by reference herein).

Aberrations can be caused for example by defects in the lens, such as holes in the lens, chips missing from an edge of the lens or other physical imperfections. Aberrations can be detected by automated inspection means and an imperfect lens can be properly rejected.

However, aberrations may also be caused by conditions in the presentation of a lens that is otherwise physically intact. For example, following hydration, a lens may have folded over itself for some portion, or an air bubble may have become trapped underneath the lens or on top of the lens. False rejections may therefore be registered by the automated inspection of a lens that detects an aberration caused by a hydration related condition but which is otherwise physically suitable for use. A false rejection typically results in a good lens being discarded and diminishing line yields.

What is needed therefore are methods and systems for minimizing unwarranted rejections by removing air bubbles on the hydrated lens and to also decreasing the incidence of lenses folding over upon themselves.

### SUMMARY

Accordingly, the present invention provides improved methods and apparatus for processing an ophthalmic lens. The ophthalmic lens is contained in a lens receptacle, such as, for example, a front curve mold piece, and exposed to a processing aid solution comprising RCO₂CH₂CH₂0(CH₂CH₂O)ₓCH₂CH₂O₂CR where R comprises (equals) at least one of: CF₃CF₂(CF2)ₓCH₂; CH₃CH₂(CH2)ₓCH₂; and Ry[Si(CH₃)2o]ₓ(CH2)₃; after which the lens is inspected in the lens receptacle with an automated lens inspection device. The processing aid solution is then rinsed from the ophthalmic lens.

In some embodiments, the lens receptacle includes a mold part utilized to fashion the lens, such as, for example, a front curve mold part. The lens can be exposed to the processing aid solution, for example, by submersing the lens in the solution or depositing the solution onto the lens. The lens may be exposed to the processing aid solution, for example, for a period of between about 30 and 900 seconds. In some embodiments, the processing aid solution includes a concentration of RCO₂CH₂CH₂0(CH₂CH₂O)ₓCH₂CH₂O₂CR of about 50 ppm to 500 ppm and in other embodiments, the processing aid solution includes a concentration of RCO₂CH₂CH₂0(CH₂CH₂O)ₓCH₂CH₂O₂CR of about 25 ppm to 1000 ppm.

In some specific embodiments, the step of exposing the lens to the processing aid solution includes depositing between about 1 ml to 5 ml of RCO₂CH₂CH₂0(CH₂CH₂O)ₓ CH₂CH₂O₂CR in a concentration of about 50 ppm to 500 ppm into a cavity in the lens receptacle containing the lens. In still other embodiments, the processing aid solution includes about 90% of a solution comprising a concentration of RCO₂CH₂CH₂0(CH₂CH₂O)ₓCH₂CH₂O₂CR of about 50 ppm to 500 ppm and about 10% of a perfluorinate aliphatic moiety.

In another aspect of the present invention, the step of inspecting the lens with an automated lens inspection device can include directing a light through the lens to form an image of the lens on a image plane and analyzing the image with a computer processor to determine if defects are present in the lens.

Still other aspects of the present invention include an improved method of forming an ophthalmic lens in a mold part by depositing a lens forming mixture into a cavity formed by two or more mold parts wherein at least one of the mold parts is transparent to polymerization initiating radiation and the cavity comprises the shape and size of an ophthalmic lens and exposing the mold parts and the polymerizable composition to polymerization initiating radiation to form the ophthalmic lens. The mold parts are separated such that the formed ophthalmic lens remains attached to a first mold parts. The ophthalmic lens in the first mold part is exposed to a solution suitable to cause the lens to release from the first mold part and additionally exposed to a processing aid solution comprising RCO₂CH₂CH₂0(CH₂CH₂O)ₓCH₂CH₂O₂CR where R comprises (equals) at least one of: CF₃CF₂(CF2)ₓCH₂; CH₃CH₂(CH2)ₓCH₂; and Ry[Si(CH₃)2o]ₓ(CH2)₃, for a time period of between 30 and 2400 seconds.

Embodiments include a lens forming mixture that includes a hydrogel formulation, such as, for example, acquafilcon A, balafilcon A, lotrafilcon A, etafilcon A, genifilcon A, lenefilcon A, polymacon and galyfilcon A, and senofilcon A.

Still another aspect of the present invention includes apparatus and automated control systems for implementing the steps of the invention.

### DESCRIPTION OF THE DRAWINGS

FIG. 1 illustrates a block diagram of an improved lens inspection system

FIG. 2 illustrates improved illumination and imaging subsystems.

FIG. 3 illustrates an exemplary ophthalmic lens which may be inspected according to the present invention.

FIG. 4 illustrates a side view of the ophthalmic lens of FIG. 3.

FIG. 4A illustrates a magnified view of a portion of an outer annulus of the ophthalmic lens of FIG. 3.

FIG. 5 illustrates a lens package that may be used to hold an ophthalmic lens to be inspected according to the present invention.

FIG. 6 is a side view of the package of FIG. 5.

FIG. 7 illustrates a pallet that can be used to carry a plurality of lens packages, such as those illustrated in FIG. 5.

FIG. 8 illustrates method steps that can be used to implement some embodiments of the present invention.

FIG. 9 illustrates additional method steps that can be used to implement embodiments of the present invention.

FIG. 10 illustrates a prior art mold assembly which can be utilized in some embodiments of the present invention.

FIG. 11 illustrates a network diagram including components of the present invention.

FIG. 12 illustrates a controller that can be utilized in conjunction with some embodiments of the present invention.

### DETAILED DESCRIPTION OF THE INVENTION

Accordingly, the present invention includes systems and methods for providing a processing aid that facilitates the inspection of ophthalmic lenses.

During manufacture of ophthalmic lenses, chips, tears and other defects in a lens can be detected by specialized inspection systems that create an image of each lens and analyze each image with a computer processor to spot aberrations. Lenses that the analysis indicates are defective can be physically segregated from good lenses, such as, for example, via an automated robot situated to accept or reject each lens.

However, in some instances, an otherwise acceptable lens may be determined by the inspection system analysis to be defective due to one or more of: air bubbles on the surface of a lens and a lens being folded over onto itself. Such false defects can have a significant effect on manufacturing yields unless they are relieved.

According to the present invention, a processing aid and improved inspection system can include a processing aid solution dispenser and a transport subsystem for moving the lenses from the processing aid dispenser into an inspection position. In addition, the present invention can include an illumination subsystem to generate a light beam and to direct the light beam through the lenses. The system can further include an imaging subsystem to generate a set of signals representing selected portions of the light beam transmitted through the lenses, and a processing subsystem to process those signals according to a predetermined program. The illumination subsystem can include a light source to generate a light beam and a diffuser to form that light beam with a generally uniform intensity across a transverse cross section of the light beam. The illumination subsystem can further include a lens assembly to focus a portion of the light beam onto an image plane, and to focus a portion of the light beam onto a focal point in front of the image plane to form a diffuser background pattern on the image plane.

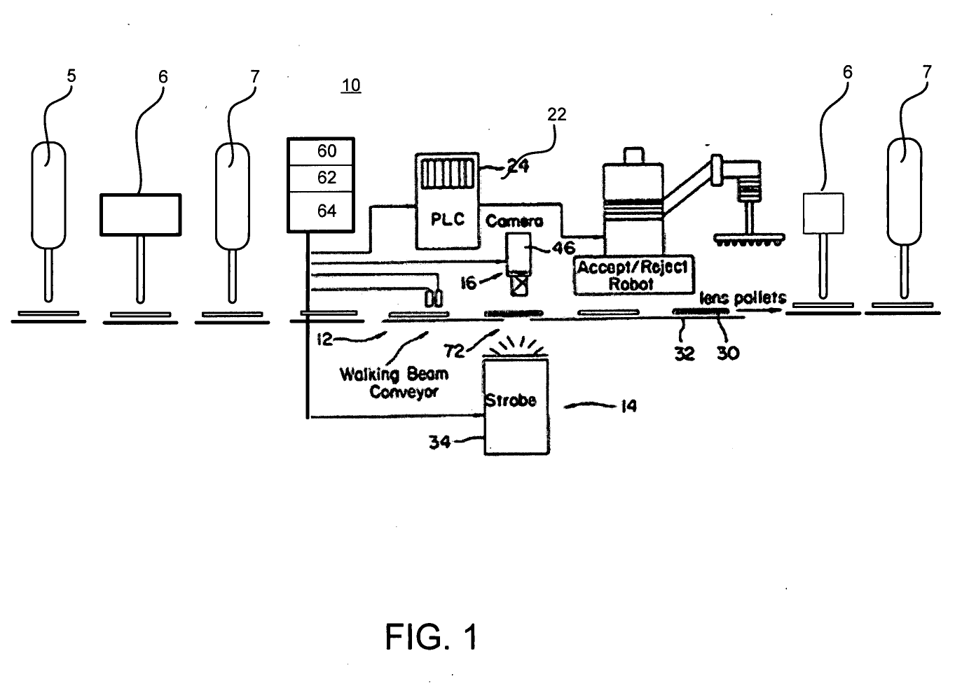

FIG. 1 illustrates an exemplary processing aid dispenser 5 and a lens inspection system 10. Generally, processing aid dispenser 5 includes one or more electro mechanical devices, each capable of administering a predetermined dose of processing solution onto an ophthalmic lens. The lens inspection system 10 generally includes, a transport subsystem 12, an illumination subsystem 14, an imaging subsystem 16 and a processing subsystem 20. FIG. 1 also illustrates a reject mechanism 22 for removing rejected lenses, reject controller 24 for controlling the reject mechanism 22, and a plurality of pallets 30. Each pallet 30 can hold, for example, a group of lens packages.

According to some embodiments of the present invention, prior to inspection by the lens inspection system 10, the processing aid dispenser 8 dispenses a processing aid solution onto ophthalmic lenses, wherein the processing aid solution includes RCO₂CH₂CH₂0(CH₂CH₂O)ₓCH₂CH₂O₂CR, where R includes at least one of: CF₃CF₂(CF2)ₓCH₂; CH₃CH₂(CH2)ₓCH₂; and Ry[Si(CH₃)2o]ₓ(CH2)₃. The processing aid dispenser 5 can include for example a pump and a dose head (not illustrated), wherein the pump provides the processing aid solution to the dose head under pressure adequate for dispensing accurate amounts of processing aid solution to each of the lenses. In some embodiments, the processing aid dispenser can be controlled by a computer processor and executable software.

Dosing with the processing aid dispenser can include, for example, directing a flow of aqueous processing aid solution into each lens holder and onto each lens. The processing aid solution that is dispensed into each ophthalmic lens holder, can include, for example one or more of: an aqueous PEG 150 distearate solution or a solution that includes RCO₂CH₂CH₂0(CH₂CH₂O)ₓCH₂CH₂O₂CR, where R includes at least one of: CF₃CF₂(CF2)ₓCH₂; CH₃CH₂(CH2)ₓCH₂; and Ry[Si(CH₃)2o]ₓ(CH2)₃. In some embodiments, the processing aid solution can include a concentration of the PEG 150 distearate of about 50 parts per million (ppm) to 500 ppm In other embodiments, the processing aid solution can include a concentration of the PEG 150 distearate of about 25 ppm to about 1000 ppm Some embodiments can also include a processing aid solution that includes up to about 10% of perfluorinate aliphatic moiety.

In still other embodiments, dosing can include, for example, one or more of: introduction of the processing aid solution under pressure into the lens carrier, in a stream, droplets, continuous and intermittent flows and processing aid solution introduced in the form of a vapor. Accordingly, in some embodiments, dosing can include depositing between 1 ml and 5 ml of RCO₂CH₂CH₂0(CH₂CH₂O)ₓCH₂CH₂O₂CR, where R includes at least one of: CF₃CF₂(CF2)ₓCH₂; CH₃CH₂(CH2)ₓCH₂; and Ry[Si(CH₃)2o]ₓ(CH2)₃ in a concentration of about between 50 ppm to 500 ppm or about 25 ppm to 1000 ppm into a cavity in a lens receptacle containing a lens. The lens receptacle can include, for example, a back curve lens mold.

Still further embodiments can include a processing aid in the form of a solution a hydrophilic-lipophilic balance (hereinafter “HLB”) in the range of 8 to 35. HLB is a term of art familiar to one of ordinary skill in the art and refers to the amount of hydrophilic and lipophilic moieties present in a non-ionic molecule.

Block copolymers, which are surface active, are classified by the ratio of the hydrophilic and lipophilic segments in eh molecule. A large number of commercial emulsifying agents, such as surfactants, have been assigned a HLB number. In some cases, the number is calculated from the structure of the molecule and in others, it is calculated based upon experimental emulsification data. Alternatively, HLB numbers have been evaluated by other methods, e.g., cloud points, gas chromatography, critical micelle concentrations and NMR spectroscopy. In the present invention, reference to the HLB number will be according to the structural approach.

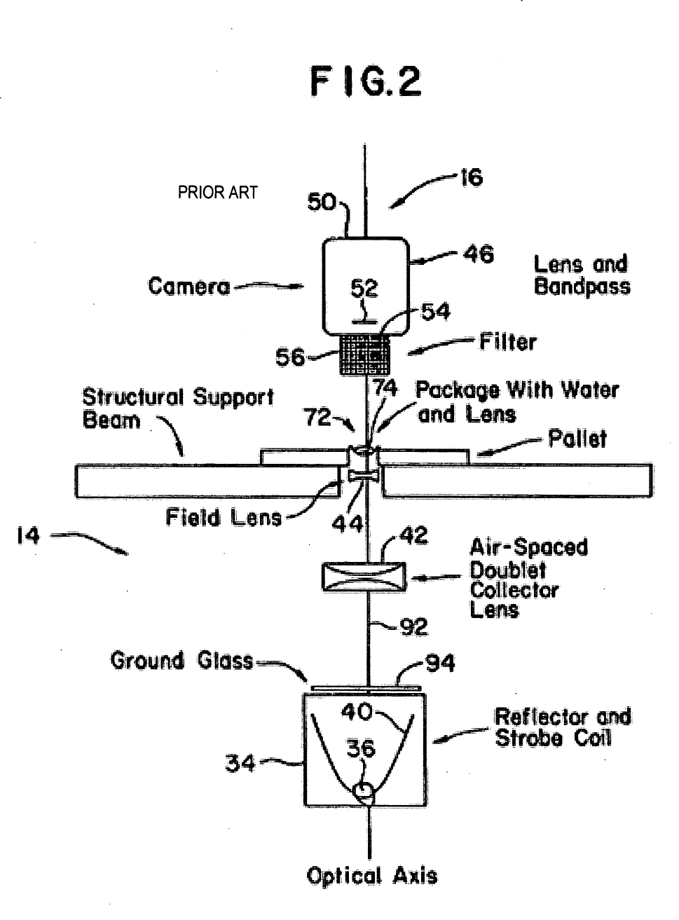

Referring now to FIGS. 1 and 2, in some embodiments transport subsystem 12 for conveying a lens from a processing aid dispenser 8 to an automated inspection system can include a conveyor belt 32; and illumination subsystem 14 with a housing 34, light source 36, reflector 40, and lenses 42 and 44. Also, in some preferred embodiments, system 10 imaging subsystem 16 includes camera 46, and camera 46, includes housing 50, pixel array 52, shutter 54, and lens assembly 56. Computer processing apparatus can include an image processor means 60, operator interface means 62, and supervisory computer 64; wherein each processor means 60, 62, 64 can include storage media and interface means such as a monitor and user input device.

Generally, transport subsystem 12 is provided to move a multitude of ophthalmic lenses along a predetermined path and into a lens inspection system, referenced at 72 in FIG. 1. Illumination subsystem 14 is provided to generate a light beam and to direct that beam through the lenses moving through the lens inspection position. Subsystem 16 generates a set of signals representing the light beam, or portions thereof, transmitted through each inspected lens, and then transmits those signals to processing subsystem 20. Subsystem 20 receives those signals from subsystem 16 and processes those signals according to a predetermined program. For each inspected lens, subsystem 20 generates a signal indicating at least one condition of the lens; and with the embodiment of subsystem 20 disclosed herein in detail, the subsystem generates a signal indicating whether each inspected lens is suitable for consumer use.

With reference again to FIG. 1, conveyor belt 32 of transport subsystem 12 is mounted on a pair, or more, of pulleys (not shown) that support the belt for movement around an endless path. One of those pulleys may be connected to a suitable drive means (not shown) to rotate the pulley and, thereby, move the conveyor belt around that endless path. Preferably, the drive means is operated so that lenses 74 are moved through system 10 in a smooth, continuous or substantially continuous manner. Alternatively, though, lenses 74 may be moved or indexed through system 10 in a discontinuous or stepwise manner, and in particular, each lens may be stopped for a brief period of time below imaging subsystem 16.

In some embodiments, the design of the system 10 is such that groups of lenses are inspected in cycles that correspond to pallet transfers. The conveying system utilizes a mechanism, referred to as a walking beam mechanism, where pallets are pushed by an arm attached to a linear slide. The slide extends to move the pallet forward. Upon completing the slide's stroke, its arm is retracted and the slide returns to its starting position to begin another pallet transfer. A complete pallet transfer occurs in three stages: a start and acceleration stage, a constant velocity stage, and a deceleration/stop stage. It is during this constant velocity stage of movement that lenses are under the cameras 46 and are being imaged. Preferably, an entire cycle takes approximately twelve seconds, and the resulting throughput is sixteen lenses approximately every 12 seconds. In addition, preferably, a single pallet cycle begins with a pallet transfer, and the pallet is at a constant velocity before reaching the camera 46 and continues at that constant speed until all the lens images have been captured.

In addition, any suitable ejector or reject mechanism 22 may be employed in system 10. Preferably, mechanism 22 is controlled by controller 24; and in particular, when controller 24 receives a signal from subsystem 20 that a lens is not suitable, the controller actuates mechanism 22 to remove the package having that lens from the stream of packages moving past the reject mechanism. In the preferred operation of system 10, in which lenses 74 are carried through the inspection system by pallets 30, controller 24 operates mechanism 22 to remove only the packages having lenses that have been determined to be unsuitable. Alternatively, a reject mechanism may be used that removes a whole pallet from system 10 in case any lens in the pallet is found unsuitable.

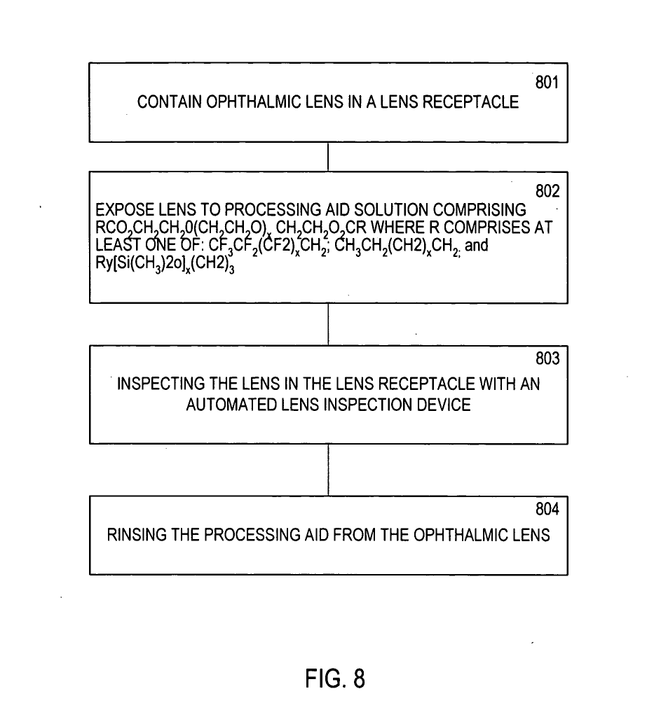

Imaging subsystem 16 receives the light beam transmitted through the lens 74 in the inspection position 72 and generates a series of signals representing that light beam. With reference to FIGS. 1 and 2, pixel array 52 is disposed inside camera housing 50, directly behind shutter 54. Pixel array 52 is preferably comprised of a multitude of light sensors, each of which is capable of generating a respective electric current having a magnitude proportional to or representing the intensity of light incident on that sensor. As is conventional, preferably the light sensors, or pixels, of pixel array 52 are arranged in a uniform grid of a given number of rows and columns, and for example, that grid may consist of approximately one million pixels arranged in approximately 1000 columns and 1000 rows. FIG. 8 schematically illustrates a portion of a pixel array, and notation used herein to refer to pixels of the array.

Preferably, the capability of the vision subsystem 16 exceeds the resolution necessary to classify all of the specified conditions for which lenses 74 are inspected. For example, a camera may be used that is capable of resolving 0.012 mm objects. With 1,048,576 pixels in the imaged area, covering a 14.495 mm field of view, each pixel covers 0.01416 mm of linear object space. Thus, a lens condition, such as an extra piece or hole, covering exactly three pixels at its largest diameter would be no more than 0.0425 mm in size. Therefore, the vision system has the capability of detecting conditions smaller than what is commonly considered as the smallest flaw for which a lens may be rejected.

Processing subsystem 20 receives the signals from imaging subsystem 16, specifically pixel array 52, and processes those signals, according to a predetermined program discussed below in detail, to identify at least one condition of the inspected lenses. More specifically, the electric signals from the pixel array 52 of camera 42 are conducted to image processor means 60. The processor means 60 converts each electric current signal from each pixel of array 52 into a respective one digital data value, and stores that data value at a memory location having an address associated with the address of the pixel that generated the electric signal.

Preferably, subsystem 20 is also employed to coordinate or control the operation of subsystems 14 and 16 so that light source 36 is actuated and camera 46 is operated in coordination with movement of lenses 74 through system 10. To elaborate, as the pallet enters the inspection area, a pallet sensor detects its presence. Upon receiving this signal, image processor 60 completes any ongoing processes from the previous pallet and then reports those results, preferably to both the PLC controller and the supervisory computer. As the pallet continues moving along the conveyor, a package sensor detects a package and generates a signal. This signal indicates that a lens is in the proper position to be imaged.

Upon receiving a package detect signal, the image processing hardware initiates an image capture and processes the image to the point where a pass/fail decision is made. As part of the image capture, a strobe is also fired to irradiate the lens. Lens pass/fail information is stored until the start of the next pallet, at which time results are reported. If a report is not received—which might happen, for example, if a sensor does not properly detect a pallet—then no further pallet transfers are allowed. The package detect sensor signals a detect for each of the eight packages found on each side of the pallet.

Even more specifically, the image processing boards determine when to image the lenses. Using fiber optic sensors, as the pallet traverses below the camera, each package edge is detected. Upon the detection of each package edge, the strobe fires, and the camera images the contact lens. The image acquisition is initiated by the image processing board by transmitting a grab signal to the camera. After the strobe firing, the stored image is transferred into the memory of one of the processor boards—referred to as the master processor—from the memory of the camera. The group master processor determines which of the other two processor boards—referred to as the slave processors—are free to inspect the image currently being received. The master processor directs where the image should be processed, informing the slave processors which of them should acquire the image data from the video bus. The master processor also monitors the inspection and final results for each image.

In some embodiments, a series of ten horizontal and ten vertical search vectors are potentially traversed. These vectors can be spaced apart equal distances from each other and the location of all vectors is such that they avoid the dark areas found in the four corners of an image.

If a lens is not found after trying all search vectors, the lens is determined to be missing. This result is reported and further processing is aborted. If a lens is found, the image coordinates that originally detected the lens are retained and further processing is continued.

Lenses

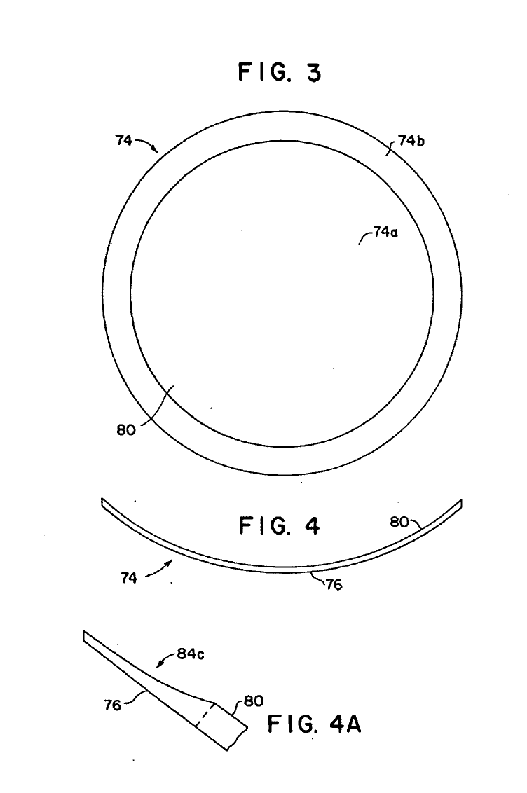

With reference now to FIGS. 3, 4, and 4A, as used herein “lens” refers to any ophthalmic device 74 that resides in or on the eye. The ophthalmic devices 74 may provide optical correction or may be cosmetic. For example, the term lens can refer to a contact lens, intraocular lens, overlay lens, ocular insert, optical insert or other similar device through which vision is corrected or modified, or through which eye physiology is cosmetically enhanced (e.g. iris color) without impeding vision.

System 10 may be used to inspect a large variety of types and sizes of ophthalmic lenses 74. Such as, for example, contact lenses which have a generally hollow, semispherical shape, including front and back surfaces 76 and 80, and the lens forms a central optical zone 74a and a peripheral zone 74b. The lens 74 can have a substantially uniform thickness; however, typically, the thickness of the lens can gradually decrease over the annulus 74c immediately adjacent the outside edge of the lens.

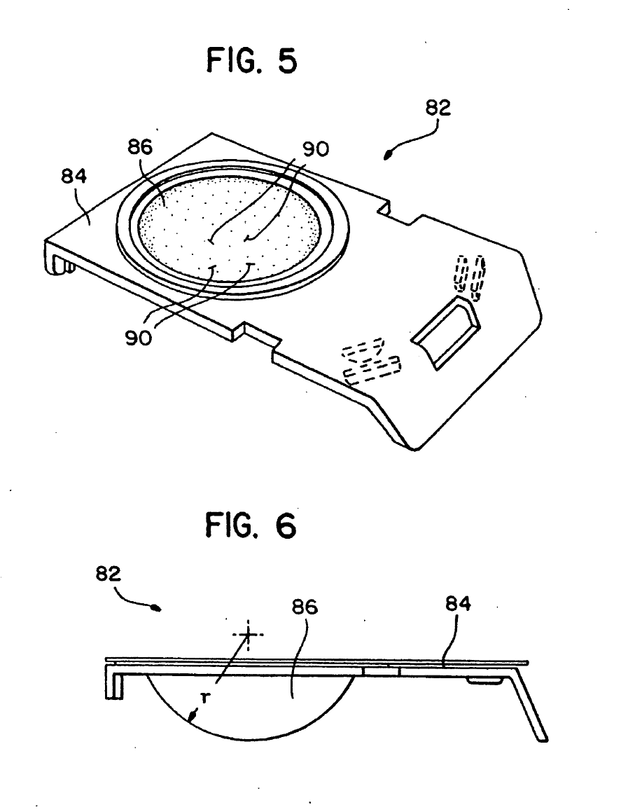

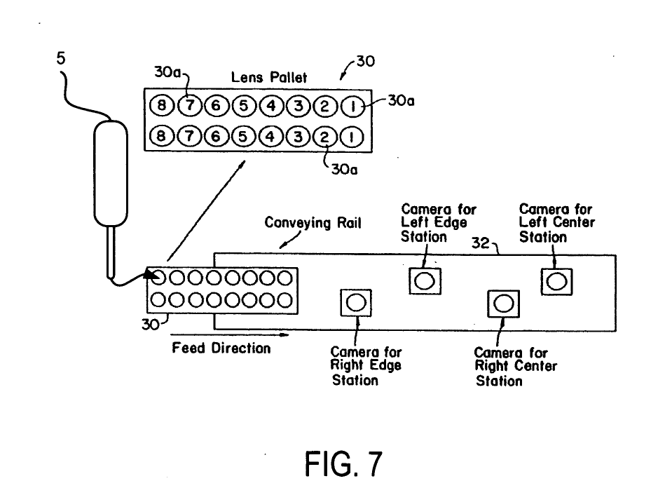

In some preferred embodiments, lenses 74 are located in individual packages or carriers, and these carriers are held in pallets 30 that are transported by conveyor 32 through the inspection position 72. Various types of lens carriers and carrier pallets may be used with system 20; and FIGS. 5 and 6 illustrate a carrier 82 that may be used to hold a lens 74, and FIG. 7 shows a pallet 30 that may be used to hold a group of packages 82.

Carrier 82 includes a substantially planar first surface 84, and formed within this planar first surface is bowl or recess 86, which is concave when viewed from the top of the carrier. A respective lens 74 is located in cavity 86 of each carrier 82; and preferably, the lens is fully submerged in a solution comprising in the carrier cavity. Preferably, the radius of curvature, r, of cavity 86 is larger than the radius of curvature of the ophthalmic lens 74 placed therein, so that when a lens 74 is placed in a cavity 86, the surfaces of the carrier 82 that form the cavity tend to center the lens at the bottom of the cavity due to the shape of the cavity.

With reference to FIG. 5, as used herein, the term “lens forming mixture” 90 refers to a mixture of materials that can react, or be cured, to form an ophthalmic lens. Such a lens forming mixture 90 can include polymerizable components (monomers), additives such as UV blockers and tints, photoinitiators or catalysts, and other additives one might desire in an ophthalmic lens such as a contact or intraocular lens. Suitable lens forming mixtures are described more fully in U.S. Pat. No. 5,849,209 (as a reactive monomer mix including cross linking agent and initiator); U.S. Pat. No. 5,770,669 (as a prepolymerization mixture including monomers and initiator); and U.S. Pat. No. 5,512,205 (as a prepolymer plus monomer system including crosslinkers and initiators).

In some embodiments, a preferred lens type can include a lens that is made from silicone elastomers or hydrogels, such as, for example, silicone hydrogels, fluorohydrogels, including those comprising silicone/hydrophilic macromers, silicone based monomers, initiators and additives. Lens forming mixtures, or soft contact lens formulations are disclosed, for example, in U.S. Pat. No. 5,710,302, WO 9421698, EP 406161, JP 2000016905, U.S. Pat. No. 5,998,498, U.S. patent application Ser. No. 09/957,299 filed on Sep. 20, 2001, U.S. patent application Ser. No. 09/532,943, U.S. Pat. No. 6,087,415, U.S. Pat. No. 5,760,100, U.S. Pat. No. 5,776,999, U.S. Pat. No. 5,789,461, U.S. Pat. No. 5,849,811 and U.S. Pat. No. 5,965,631. Further polymers that may be used to form soft contact lenses are disclosed, for example, in the following U.S. Pat. Nos. 6,419,858; 6,308,314; and 6,416,690.

By way of non-limiting example, some preferred lens types can also include etafilcon A, genifilcon A, lenefilcon A, polymacon, acquafilcon A, balafilcon A, lotrafilcon A, galyfilcon A, senofilcon A, silicone hydrogels.

Molds

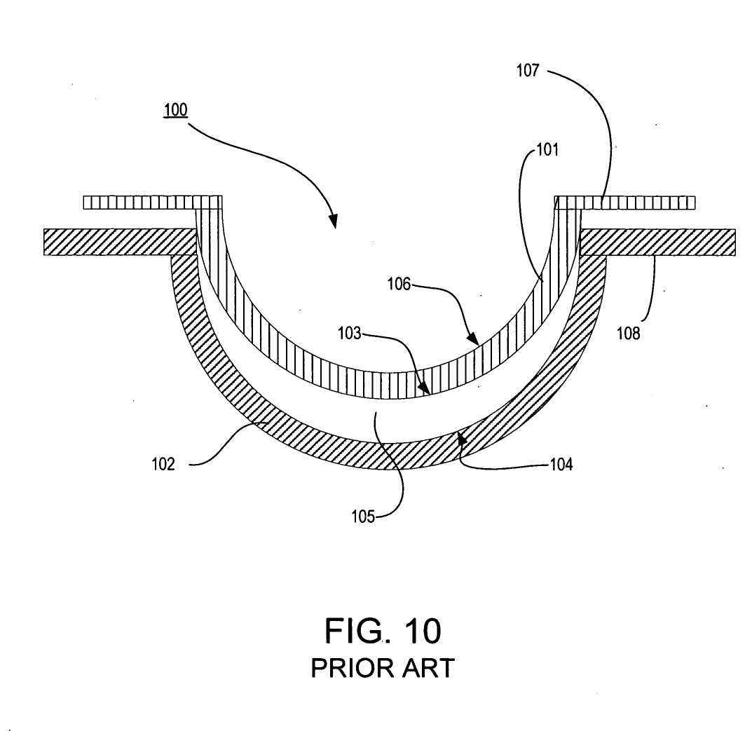

Referring now to FIG. 10, a diagram of an exemplary mold 100 for an ophthalmic lens 74 is illustrated. Soft contact lenses can be manufactured by forming the lens using a two part mold 100 where each half has topography consistent with the desired final lens 74.

Two part lens molds 100 typically contain a first part 101 with a convex surface corresponds to the back curve of a finished lens (back mold piece) and a second part 102 with a concave surface corresponds to the front curve of a finished lens (front mold piece).

To prepare lenses using these molds, the first mold portion 101 and the second mold portion 102 are brought together and an uncured lens forming mixture 90 is placed in a cavity 105 between the concave and convex surfaces of the mold portions. The lens forming mixture 90 is subsequently cured. During curing, the lens forming mixture 90 will usually adhere to the mold portions. As the lens mold portions 101-102 are separated, the cured lens forming mixture 90 will continue to adhere to one mold portion. The cured lens and the mold are subsequently treated with a liquid medium (hydrated) in order to release the cured lens from the surface of a mold portion to which it remains adhered following cure.

The portion of the concave surface 104 which makes contact with lens forming mixture has the curvature of the front curve of an ophthalmic lens to be produced in the mold assembly 100 and is sufficiently smooth and formed such that the surface of a ophthalmic lens 74 formed by polymerization of the lens forming mixture which is in contact with the concave surface 104 is optically acceptable.

In some embodiments, the front mold piece 102 can also have an annular flange integral with and surrounding circular circumferential edge 108 and extends from it in a plane normal to the axis and extending from the flange (not shown).

The back mold piece 101 has a central curved section with a convex surface 103 and circular circumferential edge 107, wherein the portion of the convex surface 103 in contact with the lens forming mixture has the curvature of the back curve of a ophthalmic lens to be produced in the mold assembly 100 and is sufficiently smooth and formed such that the surface of a ophthalmic lens formed by reaction or cure of the lens forming mixture in contact with the back surface 103 is optically acceptable. Accordingly, the inner concave surface 104 of the front mold half 102 defines the outer surface of the ophthalmic lens 74, while the outer convex surface 103 of the base mold half 101 defines the inner surface of the ophthalmic lens 74.

In some preferred methods of making molds 100 according to the present invention, injection molding is utilized according to known techniques, however, embodiments can also include molds fashioned by other techniques including, for example: lathing, diamond turning, or laser cutting.

Typically, lenses 74 are formed on at least one surface of both mold parts 101-102. However, if need be one surface of the lenses 74 may be formed from a mold part 101-102 and the other lens surface can be formed using a lathing method, or other methods.

As used herein “lens forming surface” means a surface 103-104 that is used to mold a lens. In some embodiments, any such surface 103-104 can have an optical quality surface finish, which indicates that it is sufficiently smooth and formed so that a lens surface fashioned by the polymerization of a lens forming material in contact with the molding surface is optically acceptable. Further, in some embodiments, the lens forming surface 103-104 can have a geometry that is necessary to impart to the lens surface the desired optical characteristics, including without limitation, spherical, aspherical and cylinder power, wave front aberration correction, corneal topography correction and the like as well as any combinations thereof.

Methods

Referring now to FIG. 8, some embodiments of the present invention include methods of making an ophthalmic lens 74 comprising, consisting essentially of, or consisting of the following described steps.

At 801, an ophthalmic lens 74 can be contained in a lens receptacle. At 802, the ophthalmic lens 74 is exposed to a processing aid solution comprising RCO₂CH₂CH₂0(CH₂CH₂O)ₓCH₂CH₂O₂CR where R comprises (equals) at least one of: CF₃CF₂(CF2)ₓCH₂; CH₃CH₂(CH2)ₓCH₂; and Ry[Si(CH₃)2o]ₓ(CH2)₃. At 803, the ophthalmic lens 74 can be inspected at an automated inspection system 10 such as that described above and at 804 the processing aid solution can be rinsed from the ophthalmic lens.

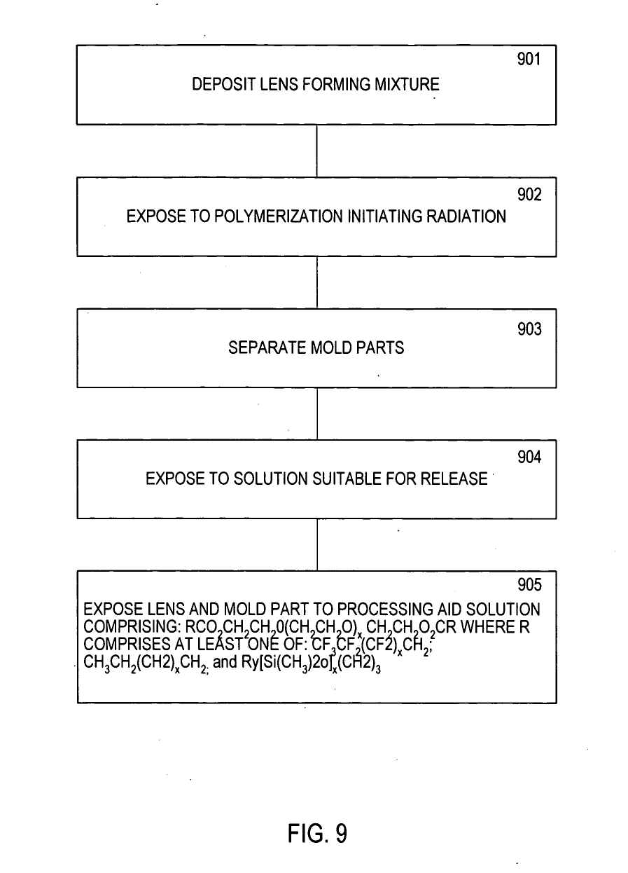

Referring now to FIG. 9, in some preferred embodiments, a lens receptacle can include, for example, a lens mold part 102 in which the lens was formed by curing a lens forming mixture deposited therein. In such embodiments, the present invention can additionally include methods of making an ophthalmic lens 74 comprising, consisting essentially of, or consisting of the following steps. At 901, a lens forming mixture 90 is deposited in a lens mold part 102 and the mold part assembled with a complimentary mold part 101. At 902, the lens forming mixture is exposed to a polymerization initiating radiation, or other initiator suitable to a particular lens forming mixture. At 903, the mold parts 101-102 are separated so that at 904, the ophthalmic lens 74 formed within the mold parts 101-102 is accessible. At 904, the ophthalmic lens 74 is exposed to a solution suitable for causing the ophthalmic lens 74 to release from a mold part 102 to which it remained attached following separation. At 905, the ophthalmic lens 74 can be exposed to a processing aid solution that includes RCO₂CH₂CH₂0(CH₂CH₂O)ₓCH₂CH₂O₂CR where R comprises (equals) at least one of: CF₃CF₂(CF2)ₓCH₂; CH₃CH₂(CH2)ₓCH₂; and Ry[Si(CH₃)2o]ₓ(CH2)₃.

Control Systems

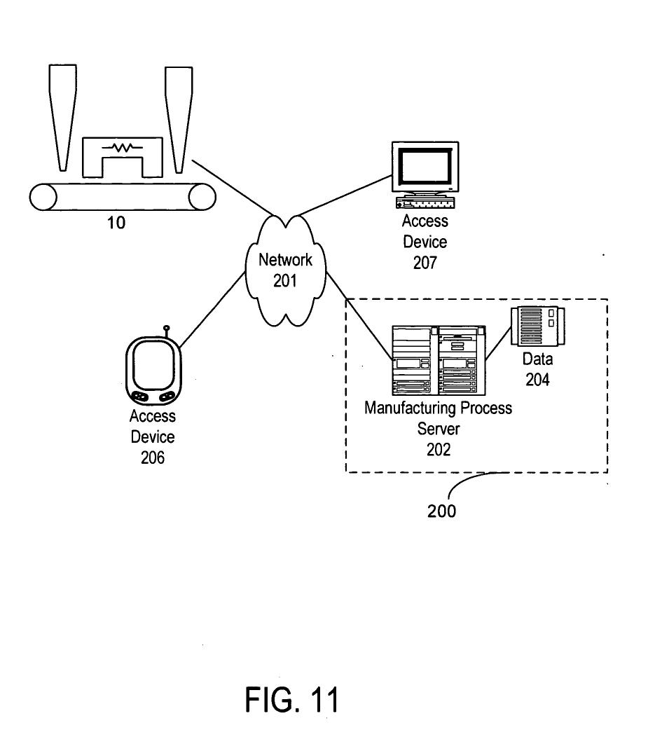

Referring now to FIG. 11, a network diagram illustrating some embodiments of the present invention is illustrated. An automated control system 200 can include a computerized server 202 accessible via a communications network 201 such as an Ethernet network. A user can use a computerized system or network access device 206-207 to receive, input, transmit or view information processed in the automated control system 200 and to control manufacturing stations, such as, for example the lens inspection system 10. A protocol, such as, for example, the transmission control protocol Internet protocol (TCP/IP) can be utilized to provide consistency and reliability.

A system access device 206-207 can communicate with the automated control system 200 to access data 204 and programs stored at the server 202. A system access device 206-207 may interact with the automated control system 200 as if the automated control system 200 were a single entity in the network 201. However, the automated control system 200 may include multiple processing and database sub-systems, such as cooperative or redundant processing and/or database servers that can be geographically dispersed throughout the network 201.

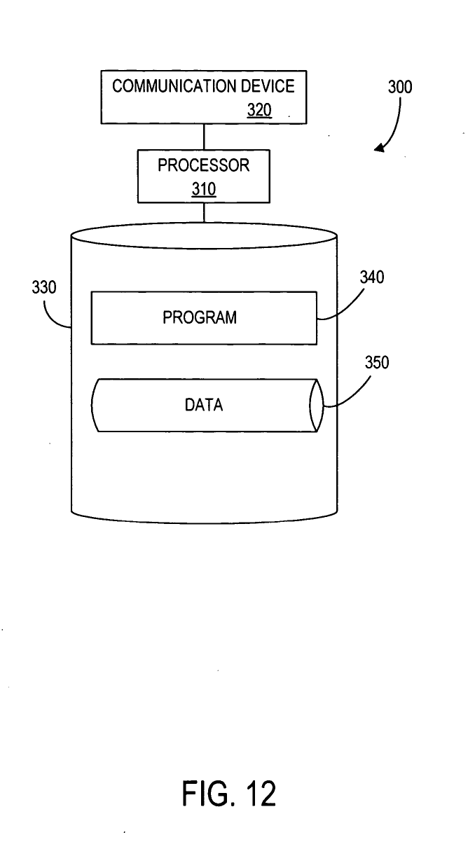

The server 202 can include a processor, memory and a user input device, such as a keyboard and/or mouse, and a user output device, such as a display screen and/or printer, as further detailed in FIG. 12. The server can also include one or more databases 204 storing data relating to manufacturing processes. Gathering data into an aggregate data structure, such as a data warehouse, allows a server to have the data readily available for processing manufacturing data and quality control data.

Typically, an access device 206-207 will access an automated control system 200 using client software executed at the system access device 206-207. The client software may include a generic hypertext markup language (HTML) browser, a proprietary browser, and/or other host access software. In some cases, an executable program, such as a Java™ program, may be downloaded from the server 202 to the system access device 206-207 and executed at the system access device 206-207 as part of an automated control system 200 program. Other implementations include proprietary software installed from a computer readable medium, such as a CD ROM.

The invention may therefore be implemented in digital electronic circuitry, computer hardware, firmware, software, or in combinations of the above. Apparatus of the invention may therefore be implemented in a computer program product tangibly embodied in a machine-readable storage device for execution by a programmable processor; and method steps of the invention may be performed by a programmable processor executing a program of instructions to perform functions of the invention by operating on input data and generating output.

In some embodiments, data contained in a database can be scrubbed or otherwise enhanced. Data scrubbing can be utilized to store information in a manner that gives efficient access to pertinent data and facilitate expedient access to data.

FIG. 12 illustrates a controller 300 that can be included in an access device 206-207 and the manufacturing process server 202, according to some embodiments of the present invention. The controller 300 includes a processor 310, such as one or more microprocessors, coupled to a communication device 320 configured to communicate via a communication network 201. The communication device 300 may be used to communicate, for example, over the network 201 with an access device 206-207 or a process station, such as the lens inspection system 10.

The processor 310 is also in communication with a storage device 330. The storage device 330 may comprise any appropriate information storage device, including combinations of magnetic storage devices (e.g., magnetic tape and hard disk drives), optical storage devices, and/or semiconductor memory devices such as Random Access Memory (RAM) devices and Read Only Memory (ROM) devices.

The storage device 330 can store a program 315 for controlling the processor 310. The processor 310 performs instructions of the program 315, and thereby operates in accordance with the present invention. For example, the processor 310 may generate control signals to operate various equipment included in manufacturing stations to implement method steps of the present invention.

The storage device 330 can store executable programs operatively functional with the processor and data related to the manufacture of ophthalmic lenses.

### CONCLUSION

The present invention, as described above and as further defined by the claims below, provides improved processing and inspection of ophthalmic lenses. A processing aid solution, such as PEG 6000, or any solution that includes RCO₂CH₂CH₂0(CH₂CH₂O)ₓCH₂CH₂O₂CR where R comprises (equals) at least one of: CF₃CF₂(CF2)ₓCH₂; CH₃CH₂(CH2)ₓCH₂; and Ry[Si(CH₃)2o]ₓ(CH2)₃, is applied to a lens in a ophthalmic lens receptacle in order to facilitate the removal of air bubbles and center the lens in the ophthalmic lens receptacle with a reduced incidence of ophthalmic lenses 74 being folded over on themselves and thereby facilitates accurate inspection of the ophthalmic lens 74.

What is claimed is:

1. An improved method of processing an ophthalmic lens, the method comprising:
containing the ophthalmic lens in a lens receptacle;
exposing said lens to a processing aid solution comprising RCO₂CH₂CH₂0(CH₂CH₂O)ₓCH₂CH₂O₂CR where R comprises (equals) at least one of: CF₃CF₂(CF2)ₓCH₂; CH₃CH₂(CH2)ₓCH₂; and Ry[Si(CH₃)2o]ₓ(CH2)₃;
inspecting the lens in the lens receptacle with an automated lens inspection device;
rinsing the processing aid solution from the ophthalmic lens.

2. The method of claim 1, wherein the lens receptacle comprises a mold part utilized to fashion the lens.

3. The method of claim 1, wherein the step of exposing the lens to the processing aid solution comprises submersion of the lens and the lens receptacle in the processing aid solution.

4. The method of claim 4, wherein the lens is submerged for a period of between about 30 and 900 seconds.

5. The method of claim 4, wherein the processing aid solution comprises a concentration of RCO₂CH₂CH₂0(CH₂CH₂O)ₓCH₂CH₂O₂CR of about 50 ppm to 500 ppm.

6. The method of claim 4, wherein the processing aid solution comprises a concentration of RCO₂CH₂CH₂0(CH₂CH₂O)ₓCH₂CH₂O₂CR of about 25 ppm to 1000 ppm.

7. The method of claim 4, wherein the step of exposing the lens to the processing aid solution comprises depositing between about 1 ml to 5 ml of RCO₂CH₂CH₂0(CH₂CH₂O)ₓCH₂CH₂O₂CR in a concentration of about 50 ppm to 500 ppm into a cavity in the lens receptacle containing the lens.

8. The method of claim 4, wherein the processing aid solution comprises about 90% of a solution comprising a concentration of RCO₂CH₂CH₂0(CH₂CH₂O)ₓCH₂CH₂O₂CR of about 50 ppm to 500 ppm and about 10% of a perfluorinate aliphatic moiety.

9. The method of claim 1 wherein the lens receptacle comprises a front curve mold piece and the processing aid solution facilitates centering the lens in the front curve mold piece.

10. The method of claim 1 wherein the step of rinsing the processing aid solution from the ophthalmic lens comprises directing a stream of DI water into the lens receptacle.

11. The method of claim 1 wherein the step of inspecting the lens with an automated lens inspection device comprises:
directing a light through the lens to form an image of the lens on a image plane; and
analyzing the image with a computer processor to determine if defects are present in the lens.

12. A method for processing an ophthalmic lens formed in a mold part to facilitate removal of wetting related conditions, the method comprising:
releasing said lens from the mold part;
exposing said lens to a processing aid solution comprising RCO₂CH₂CH₂0(CH₂CH₂O)ₓCH₂CH₂O₂CR where R comprises (equals) at least one of: CF₃CF₂(CF2)ₓCH₂; CH₃CH₂(CH2)ₓCH₂; and Ry[Si(CH₃)2o]ₓ(CH2)₃, and rinsing said processing aid from said lens.

13. A processing aid apparatus for exposing an ophthalmic lens to a processing aid, the processing aid dispenser comprising:
an automated solution dispenser for dispensing between 1 ml to 5 ml of a solution comprising RCO₂CH₂CH₂0(CH₂CH₂O)ₓCH₂CH₂O₂CR in a concentration of about 50 ppm to 500 ppm into a cavity in a front curve mold piece containing an ophthalmic lens;
a transport system for positioning the front curve mold piece in a position which enables the automated solution dispenser to dispense the solution of RCO₂CH₂CH₂0(CH₂CH₂O)ₓCH₂CH₂O₂CR into the cavity; and
an automated controller that coordinates the positioning of the front curve mold piece and the dispensing of the RCO₂CH₂CH₂0(CH₂CH₂O)ₓCH₂CH₂O₂CR solution.

14. The processing aid apparatus of claim 13 additionally comprising:
an automated inspection system for inspecting the lens; and
a rinsing station for rinsing the lens with deionized water.

15. An improved method of forming an ophthalmic lens in a mold part, the method comprising the steps of
depositing a lens forming mixture into a cavity formed by two or more mold parts wherein at least one of the mold parts is transparent to polymerization initiating radiation and the cavity comprises the shape and size of an ophthalmic lens;
exposing the mold parts and the polymerizable composition to polymerization initiating radiation to form the ophthalmic lens;
separating the two or more mold parts such that the formed ophthalmic lens remains attached to a first mold parts;
exposing the ophthalmic lens in the first mold part to a solution suitable to cause the lens to release from the first mold part; and
exposing the released lens and the first mold part to a processing aid solution comprising RCO₂CH₂CH₂0(CH₂CH₂O)ₓCH₂CH₂O₂CR where R comprises (equals) at least one of: CF₃CF₂(CF2)ₓCH₂; CH₃CH₂(CH2)ₓCH₂; and Ry[Si(CH₃)2o]ₓ(CH2)₃, for a time period of between 30 and 2400 seconds.

16. The lens of claim 15 wherein the lens forming mixture comprises a hydrogel formulation.

17. The method of claim 15 wherein the lens forming mixture comprises at least one of acquafilcon A, balafilcon A, and lotrafilcon A.

18. The method of claim 15 wherein the lens forming mixture comprises at least one of etafilcon A, genfilcon A, lenefilcon A, polymacon and galyfilcon A, and senofilcon A.

19. The method of claim 15 wherein the lens forming mixture comprises senofilcon A.

20. The method of claim 15 wherein the surface of the first mold part comprises an optical quality surface finish formed in a shape and size suitable for at least one of; a front curve of an ophthalmic lens and a back curve of an ophthalmic lens.

21. The method of claim 15 wherein the solution comprising RCO₂CH₂CH₂0(CH₂CH₂O)ₓCH₂CH₂O₂CR comprises a concentration of between 50 ppm and 500 ppm RCO₂CH₂CH₂0(CH₂CH₂O)ₓCH₂CH₂O₂CR.

22. The method of claim 15 wherein the released lens and the first mold part are exposed to a dose of the solution comprising RCO₂CH₂CH₂0(CH₂CH₂O)ₓCH₂CH₂O₂CR of between 0.5 ml and 4 ml.

23. The lens of claim 22 wherein between 0.2 and 0.4 ml of the solution comprising RCO₂CH₂CH₂0(CH₂CH₂O)ₓCH₂CH₂O₂CR remain in the mold part cavity after any additional solution in the dose flows away.

24. An improved method of forming an ophthalmic lens in a mold part, the method comprising the steps of:
depositing a lens forming mixture into a cavity formed by two or more mold parts wherein at least one of the mold parts is transparent to polymerization initiating radiation and the cavity comprises the shape and size of an ophthalmic lens;
exposing the mold parts and the polymerizable composition to polymerization initiating radiation to form the ophthalmic lens;
separating the two or more mold parts such that the formed ophthalmic lens remains attached to a first mold parts;
exposing the ophthalmic lens in the first mold part to a solution suitable to cause the lens to release from the first mold part; and
exposing the released lens and the first mold part to a processing aid solution comprising a HLB of between 8 and 30, for a time period of between 30 and 2400 seconds.

25. Automated controller apparatus for controlling a processing station utilized to process an ophthalmic lens during lens fabrication, the controller apparatus comprising:
a computer processor operatively connected to one or more processing stations via a communications network;
an electronic storage operatively connected to the computer processor; and
executable software stored on the electronic storage and executable on demand, the software operative with the processor to cause the one or more processing stations to:
expose an ophthalmic lens contained in a lens receptacle to a processing aid solution comprising RCO₂CH₂CH₂0(CH₂CH₂O)ₓCH₂CH₂O₂CR where R comprises (equals) at least one of: CF₃CF₂(CF2)ₓCH₂; CH₃CH₂(CH2)ₓCH₂; and Ry[Si(CH₃)2o]ₓ(CH2)₃; and
inspect the lens in the lens receptacle with an automated lens inspection device;
rinsing the processing aid solution from the ophthalmic lens.
